(19) United States
(12) Patent Application Publication
(10) Pub. No.: US 2014/0337804 A1
(43) Pub. Date: Nov. 13, 2014

(54) SYMBOL-BASED DIGITAL INK ANALYSIS

(71) Applicant: Microsoft Corporation, Redmond, WA (US)

(72) Inventors: Daniel J. Hwang, Newcastle, WA (US); Juan Dai, Sammamish, WA (US); Wenqi Shen, Bellevue, WA (US); Sharath Viswanathan, Seattle, WA (US); Pu Li, Sammamish, WA (US)

(21) Appl. No.: 13/891,958

(22) Filed: May 10, 2013

(51) Int. Cl. G06F 3/01

(52) U.S. Cl. CPC G06F 3/017
USPC 715/863

(57) ABSTRACT

Techniques are described for automatically performing application-specific actions based on global pre-defined symbols entered using digital ink. For example, a computing device supporting digital ink input can receive digital ink content from a user (e.g., via a digitizer and/or touchscreen), process the digital ink input to recognize text and/or graphical content, determine whether global pre-defined symbols are present in the recognized text and/or graphical content, and perform application-specific actions associated with the global pre-defined symbols that are present. The application-specific actions can be associated with built-in and/or third-party applications.

### BACKGROUND

Users are increasingly relying on their mobile devices to perform day-to-day activities. For example, users use their mobile phones to make phone calls, send email and text messages, save contact information, take notes, browse the web, and perform many other types of activities.

When performing such activities using a mobile device, users typically navigate through the applications and data on their mobile devices using a touchscreen and buttons. For example, if a user wants to make a phone call to a friend, the user may have to turn on and unlock the phone, select the phone application, select the friend (e.g., from a contact list), and dial the number to initiate the call. As another example, if the user wants to send an email message to the friend, the user may have to turn on and unlock the phone, select an email application, select the recipient field, enter or select the friend's email address, complete the subject and body, and send the email message.

While mobile devices have improved user interfaces, such as touchscreens, performing activities (e.g., the phone call and email examples discussed above) can still involve a number of manual steps. Performing a number of manual steps each time the user wants to perform a common activity can be inefficient and time consuming.

Therefore, there exists ample opportunity for improvement in technologies related to efficiently performing common activities using a computing device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for automatically performing application-specific actions based on global pre-defined symbols entered using digital ink. For example, a computing device supporting digital ink input can receive digital ink content from a user (e.g., via a digitizer and/or touchscreen), process the digital ink input to recognize text and/or graphical content, determine whether global pre-defined symbols are present in the recognized text and/or graphical content, and perform application-specific actions associated with the global pre-defined symbols that are present. The application-specific actions can be associated with built-in and/or third-party applications.

For example, a method can be provided for automatically performing application-specific actions based on global pre-defined symbols entered using digital ink. The method can be performed, at least in part, by a computing device such as a mobile phone that supports digital ink input. The method comprises receiving digital ink content that is input in a digital ink mode, processing the received digital ink content, based on results of the processing, determining whether the digital ink content comprises a global pre-defined symbol, and when the digital ink content comprises the global pre-defined symbol, performing an application-specific action associated with the global pre-defined symbol.

The global pre-defined symbol can be one of a plurality of global pre-defined symbols and associated application-specific actions. The global pre-defined symbol can be a globally recognized symbol across applications (e.g., built-in and third-party applications) running on a computing device.

The global-predefined symbol can be a system-defined symbol that is associated with an application-specific action for a built-in application. The global pre-defined symbol can also be a user-defined symbol that is associated with a user-defined application-specific action.

As another example, computing devices comprising processing units, memory, and input devices supporting digital ink can be provided for performing operations described herein. For example, a mobile computing device, such as a mobile phone, can perform operations for automatically performing application-specific actions based on global pre-defined symbols entered using digital ink.

As described herein, a variety of other features and advantages can be incorporated into the technologies as desired.

### BRIEF DESCRIPTION OF THE DRAWINGS

FIG. 1 is a flowchart of an example method for automatically performing application-specific actions based on global pre-defined symbols entered using digital ink.

FIG. 2 is a flowchart of an example method for performing an application-specific action based on a detected global pre-defined symbol.

FIG. 3 depicts example screenshots for automatically performing an email action based on a global pre-defined symbol entered using digital ink.

FIG. 4 depicts an example screenshot for automatically creating a new contact based on global pre-defined symbols entered using digital ink.

FIG. 5 is a diagram of an exemplary computing system in which some described embodiments can be implemented.

FIG. 6 is an exemplary mobile device that can be used in conjunction with the technologies described herein.

FIG. 7 is an exemplary cloud-support environment that can be used in conjunction with the technologies described herein.

### DETAILED DESCRIPTION

### Example 1

### Overview

As described herein, various techniques and solutions can be applied for automatically performing application-specific actions based on global pre-defined symbols entered using digital ink. For example, a computing device supporting digital ink input (e.g., a mobile phone or tablet) can receive digital ink content from a user (e.g., via a digitizer and/or touchscreen), process the digital ink input to recognize text and/or graphical content, determine whether global pre-defined symbols are present in the recognized text and/or graphical content, and perform application-specific actions associated with the global pre-defined symbols that are present.

A computing device, such as a mobile phone, tablet, or another type of computing device, can support a number of global pre-defined symbols that are recognized across the device (e.g., recognized regardless of which application or applications are currently running on the device). For example, the global pre-defined symbols can be recognized (e.g., by an operating system or other built-in software) when the user is using a built-in application (e.g., a desktop or start screen application, an email application, a web browser application, a phone application, etc.) and when the user is using a third-party application (e.g., a game application, a social network application, etc.).

The global pre-defined symbols can be system-defined symbols. For example, a number of system-defined symbols can be provided for performing application-specific actions for built-in applications (e.g., system-defined symbols for performing actions associated with email applications, contact applications, phone applications, and other built-in applications).

The global pre-defined symbols can be user-defined symbols. For example, a user can edit system-defined symbols to use user-selected symbols (e.g., change a system-defined symbol for performing an email action from the at sign “@” to the letter “e”) and/or to perform a different action. The user can also create new user-defined symbols (e.g., user-defined text-based symbols and/or user-defined graphical symbols) that are globally recognized across the device. For example, the user can create a user-defined symbol for automatically calling a specific contact (e.g., create a graphical heart symbol for automatically calling the user's spouse).

### Example 2

### Digital Ink

Digital ink refers to the ability to write or draw on a computing device. For example, a computing device, such as a mobile phone or tablet computer, can be equipped with technology that digitizes input from a user using a pen or stylus (e.g., using inductive or capacitive technology). Other types of computing devices can also be used for digital ink input, such as a laptop or desktop computer equipped with an input device supporting digital ink. Furthermore, a separate digitizing device can be used for digital ink input, such as a graphics tablet or touchpad. In some implementations, a computing device with a touchscreen (e.g., a mobile phone or tablet) can support digital ink (e.g., by writing or drawing with the user's finger).

Digital ink can be used to simulate traditional pen and paper writing. For example, a user can use a stylus, pen, or another object, to write on a digitizing screen or digitizing device as the user would write with traditional pen and paper. The content written by the user can remain in written format and/or converted to text (e.g., using handwriting recognition technology).

When the user writes or draws on the input device supporting digital ink (e.g., a touchscreen supporting digital ink, digitizing device supporting digital ink, or another type of input device supporting digital ink), the digital ink content is captured. The digital ink content can be captured and presented in handwritten format (e.g., as handwritten text or drawing content) and/or converted to text format (e.g., using digital ink recognition, which can be used to recognize text and/or graphical content).

In some implementations, digital ink input is performed using a pen or stylus (e.g., using digitizing technology). In other implementations, digital ink input is performed using a finger (e.g., using a touchscreen device). In yet other implementations, digital ink input can be performed using a pen or stylus (or another type of object) and by a person's finger. Depending on the technology used, some types of input may perform differently (e.g., a pen or stylus may have improved resolution and/or precision over input using a person's finger).

### Example 3

### Digital Ink Content

Digital ink content refers to the handwritten content input using digital ink. For example, a user can input handwritten content (e.g., text and/or graphical content) using a computing device that supports digital ink. Digital ink content can represent written text (e.g., words, letters, numbers, etc.) and/or graphical content (e.g., graphical symbols or other graphical content).

For example, a user can input digital ink content with a pen or stylus using a computing device with a digitizing display. As another example, a user can input digital ink content with the user's finger using a computing device (e.g., a mobile phone or tablet) with a touchscreen display. As yet another example, some computing devices support digital ink input using both a pen or stylus (or another object) and a user's finger.

Digital ink content can be input in a digital ink mode. The digital ink mode can be a standard or default input mode of a device. For example, a computing device that uses a stylus or pen as its default input device can receive input in a digital ink mode (e.g., without the user having to do anything to switch to a digital ink mode). The digital ink mode can also be automatically selected. For example, a computing device can automatically switch to a digital ink mode (e.g., from a touch input mode) when input using a pen or stylus is detected or when a particular input device is used (e.g., a graphics tablet). The digital ink mode can also be a user-selected mode. For example, a button or icon can be selected by the user to switch to the digital ink mode (e.g., when the user wants to enter digital ink content using a pen, stylus, or the user's finger).

Digital ink content can remain in handwritten format (e.g., as handwritten text or graphical content). For example, a user can be typing a word processing document using a keyboard. When the user wants to add a freehand drawing, the user can enter the drawing using digital ink on the touchscreen of the user's device (e.g., a mobile phone, tablet, laptop, or another type of computing device with a touchscreen). The entered drawing can remain in handwritten format.

Digital ink content can be converted to a different format. For example, digital ink content can be recognized and converted into text content using digital ink recognition. Digital ink recognition refers to technology, such as handwriting recognition, that recognizes text content (e.g., letters, numbers, characters, and other text content, such as from English and/or non-English language character sets). Digital ink recognition can also recognize graphical content (e.g., symbols and other graphical content).

### Example 4

### Digital Ink Symbols

As used herein, symbols refer to digital ink content that is recognized (e.g., using digital ink recognition) as having a specific (e.g., special) meaning. For example, digital ink content can be received by a computing device and processed using digital ink recognition to determine whether one or more symbols are present in the digital ink content.

Digital ink symbols can comprise text-based symbols (e.g., alphanumeric text in a Latin-based language or character set and/or text or numbers in a non-Latin-based language or character set). For example, a text-based symbol can be a letter (e.g., the letter “h” or the letter “k”), a number (e.g., the number “5”), or another type of text-based symbol (e.g., an at symbol “@”, number sign “#”, etc.). A text-based symbol can also comprise a sequence of characters (e.g., the letters “ph” or the sequence “n:”).

Digital ink symbols can also comprise graphical symbols (e.g., a heart, smiley face, or other type of graphical symbol). Graphical symbols can be defined by a user. For example, a user can enter a graphical symbol using digital ink (e.g., draw a graphical heart symbol with a pen or stylus). The computing device can then save the graphical symbol entered by the user and recognize it later (e.g., by recognizing the pattern using digital ink recognition).

### Example 5

### Global Pre-Defined Symbols

As used herein, global pre-defined symbols are digital ink symbols that are globally recognized on a computing device regardless of which application is currently in use. For example, global pre-defined symbols can be recognized by the operating system (or other built-in software) of the computing device across built-in applications (e.g., including an email application, a contacts application, a photo application, a desktop or start screen, a lock screen, etc.) and third-party applications (e.g., social networking applications, games, and other third-party applications which may be downloaded and installed by a user from an app store) running on the computing device.

In some implementations, digital ink content is received and processed (e.g., by the operating system) to determine whether any global pre-defined symbols are present in the digital ink content. For example, the digital ink content can be received and processed by the operating system before being passed to an application. If the digital ink content contains a global pre-defined symbol, then some action can be taken (e.g., an application-specific action). The action may involve launching or switching to another application. For example, a user can be playing a game on a mobile phone. The user can enter digital ink content using a pen or stylus (or the user's finger), which can be recognized by the operating system as containing a global pre-defined symbol. The operating system can then launch a different application for performing an application-specific action associated with the recognized global pre-defined symbol (e.g., switch from the game application to an email application to perform an email action associated with the recognized global pre-defined symbol).

Global pre-defined symbols can include system-defined symbols. For example, a computing device can include a number of system-defined symbols (e.g., recognized by the operating system of the computing device). The system-defined symbols can be associated with built-in applications of the computing device.

Global-predefined symbols can also include symbols that are created or edited by a user. For example, a user can edit an existing system-defined symbol (e.g., change the symbol and/or change the application-specific action tied to the symbol). A user can also create a new symbol and tie it to an application-specific action. For example, a user can create a graphical symbol (e.g., a graphical heart symbol drawn by the user using digital ink) and tie it to an application-specific action for creating a new email message to the user's spouse.

### Example 6

### Methods for Automatically Performing Application-Specific Actions Based on Global Pre-Defined Symbols

In any of the examples herein, methods can be provided for automatically performing application-specific actions based on global pre-defined symbols entered using digital ink. For example, the methods can be performed by a computing device (e.g., by the operating system and/or other built-in software of the computing device). The computing device can receive and process digital ink content, determine whether global pre-defined symbols are present in the digital ink content (e.g., by recognizing the symbols using digital ink recognition), and perform application-specific actions according to which symbols are present in the digital ink content.

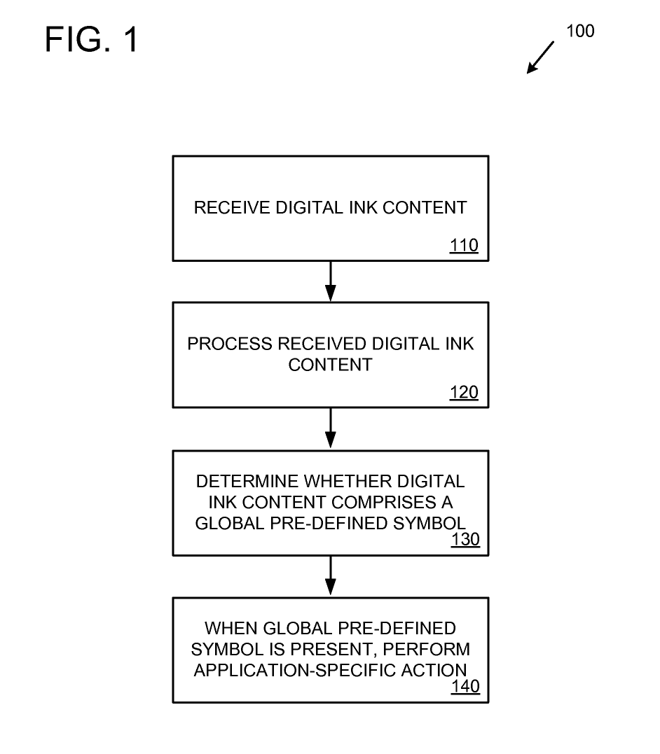

FIG. 1 is a flowchart of an example method 100 for automatically performing application-specific actions based on global pre-defined symbols entered using digital ink. The example method 100 can be performed, at least in part, by a computing device, such as a mobile phone.

At 110, digital ink content is received from a user of a computing device. The digital ink content is received in a digital ink mode. For example, the digital ink content can be received by the user using a pen, stylus, or the user's finger to draw on an input device (e.g., a digitizer or touchscreen) of the computing device that supports digital ink.

At 120, the digital ink content received at 110 is processed. Processing the digital ink content can comprise recognizing text and/or non-text content within the digital ink content. For example, digital ink recognition can be applied to recognize text content (e.g., letters, numbers, etc.) and/or non-text content (e.g., graphical content).

At 130, whether the digital ink content comprises a global pre-defined symbol is determined. The determination is based on results of the processing performed at 120. For example, digital ink recognition can produce an indication of the text and/or non-text elements present in the digital ink content. For example, if the digital ink content comprises “@ Lynn; Wenqi” in handwritten format, digital ink recognition can recognize the text content and produce the content “@ Lynn; Wenqi” in text format. As another example, if the digital ink content comprises a graphical heart, the digital ink recognition can recognize the heart symbol (e.g., by comparing to a set of known symbols using pattern recognition, stroke recognition, image comparison, etc.) and produce an indication that the digital ink content contains a heart symbol. From the recognized text and non-text elements, global pre-defined symbols can be detected (e.g., by comparing to a set of global pre-defined symbols to determine if there is a match).

At 140, when a global pre-defined symbol is present in the digital ink content, an application-specific action associated with the global pre-defined symbol is performed. For example, a list of global pre-defined symbols and their associated application-specific actions can be maintained. When one of the global pre-defined symbols is detected in the digital ink content, its corresponding application-specific action can be performed.

In some implementations, an application-specific action can be associated with more than one global pre-defined symbol. For example, a set of global pre-defined symbols can be associated with an application-specific action for creating a new contact (e.g., a first symbol for identifying the name of the contact, a second symbol for identifying the phone number of the contact, a third symbol for identifying the email address of the contact, and so on). In some implementations, a first global pre-defined symbol can be associated with the application-specific action, with additional global pre-defined symbols being optional (e.g., to supply additional information for use by the application-specific action).

In some implementations, performing the application-specific action associated with the global pre-defined symbol comprises launching an application (e.g., if the application is not currently running), or switching to the application (e.g., if the application is currently running, such as in the background), and passing parameters to the application to accomplish the application-specific action. For example, if the global pre-defined symbol is associated with an application-specific action for creating a new email message within an email application, then performing the application-specific action can comprise launching (or switching to) the email application and passing parameters (e.g., data and/or commands) to start a new email message, lookup a contact, and populate the “to” field of the new email message with the contact email address.

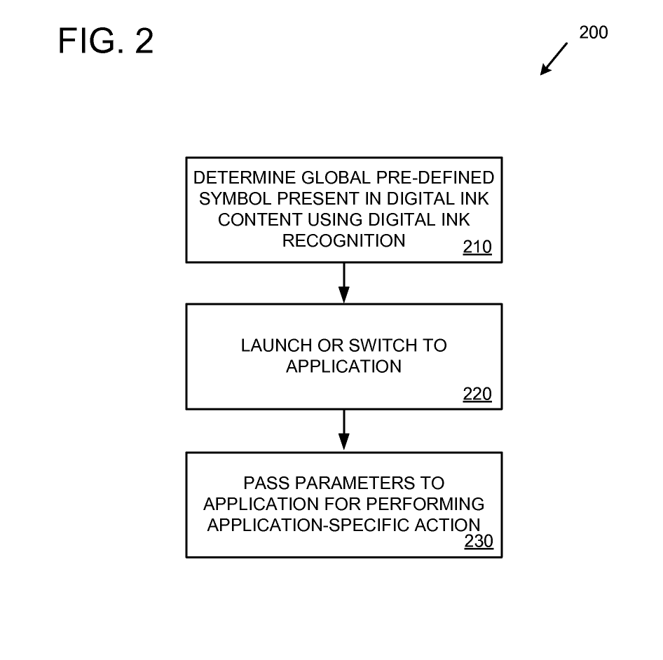

FIG. 2 is a flowchart of another example method 200 for performing an application-specific action based on a detected global pre-defined symbol. At 210, a determination is made that a global pre-defined symbol is present in digital ink content using digital ink recognition. The global pre-defined symbol is associated with an application-specific action. The application-specific action can comprise information identifying a particular application (e.g., a built-in application or a third-party application) and information identifying parameters to be passed to the particular application (e.g., data, commands, operations, and/or other types of parameters).

At 220, the application is launched or, if the application is already running, the application is switched to. For example, the operating system can determine that the global pre-defined symbol is present in the digital ink content, lookup the application-specific action associated with the global pre-defined symbol, and launch (or switch to) the application identified by the application-specific action.

At 230, parameters are passed to the application for performing the application-specific action. For example, the parameters can comprise data (e.g., other portions of the digital ink content), commands, and/or other information for carrying out the application-specific action using the application.

For example, a global pre-defined symbol can be detected in digital ink content for performing a search action. As an example, the symbol could be the letter “s”, the letters “srch”, or a custom user-defined graphical symbol. The symbol can be followed by a search string parameter. For example, the user can enter “s sushi restaurant” to search for nearby sushi restaurants. Upon receiving the digital ink content and detecting the global pre-defined symbol, the computing device can launch the search application (e.g., a built-in search application or a search page using a web browser application), fill in the search string from the digital ink content (e.g., “sushi restaurant”), and initiate the search.

### Example 7

### Example Implementations

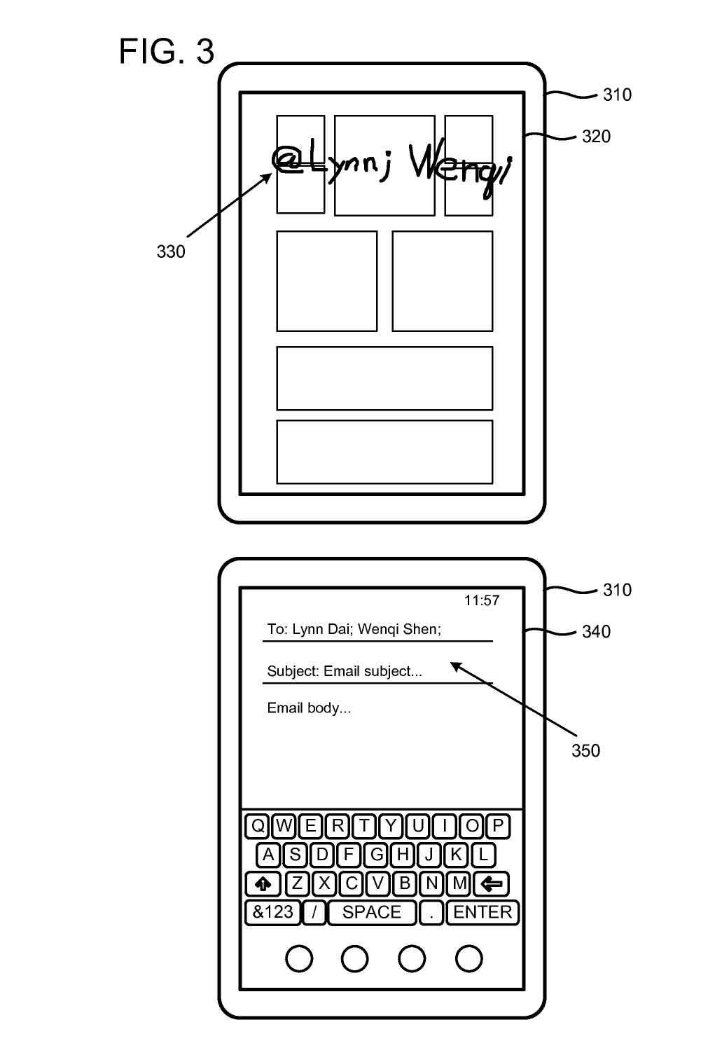

FIG. 3 depicts an example implementation for automatically performing an email action based on a global pre-defined symbol entered using digital ink. FIG. 3 depicts a computing device 310 with a display (e.g., a mobile phone, tablet, or another type of computing device). The computing device 310 is capable of receiving digital ink input (e.g., via a digitizer, touchscreen, graphics tablet, etc.).

As depicted in the first example screenshot 320 of the display of the computing device 310, a user has entered digital ink content 330. The digital ink content depicted in the example screenshot 320 is the handwritten digital ink content, “@ Lynn; Wenqi.” The computing device can process the digital ink content (e.g., perform digital ink recognition) to convert the digital ink content to text. Once the digital ink content has been processed, global pre-defined symbols can be recognized. In this example, the at symbol “@” is a global pre-defined symbol that is associated with an application-specific action for creating a new email message addressed to one or more contacts that follow the at symbol in the digital ink content. In this example, there are two contacts following the global pre-defined symbol, contacts “Lynn” and “Wenqi.” For example, the computing device 310 can look up the contacts (e.g., on a contacts database) to determine their display names, email addresses, etc.

The example digital ink content 330 can be entered by the user regardless of which application the user is using (e.g., which application is currently being displayed). For example, the user could be using the desktop, a built-in application (e.g., an email application, a music application, a photos application, etc.), or a third-party application (e.g., a game application, etc.). Regardless of which application is being displayed on the display of the computing device 310, the user can enter digital ink content, and if the digital ink content contains a global pre-defined symbol, then the corresponding application-specific action can be performed. For example, the global pre-defined symbol can be recognized without involving the currently displayed application (e.g., by receiving and processing the digital ink content by the operating system without involving the currently displayed application).

As depicted in the second example screenshot 340 of the display of the computing device 310, an email application has been launched as a result of detecting the global pre-defined symbol (the at sign “@” in this example). The two contacts in the digital ink input (which followed the global pre-defined symbol) have been automatically inserted into the “to” field of the new email message, as depicted at 350. The user can then finish the email message (e.g., enter a subject and body for the email message) and send the email message.

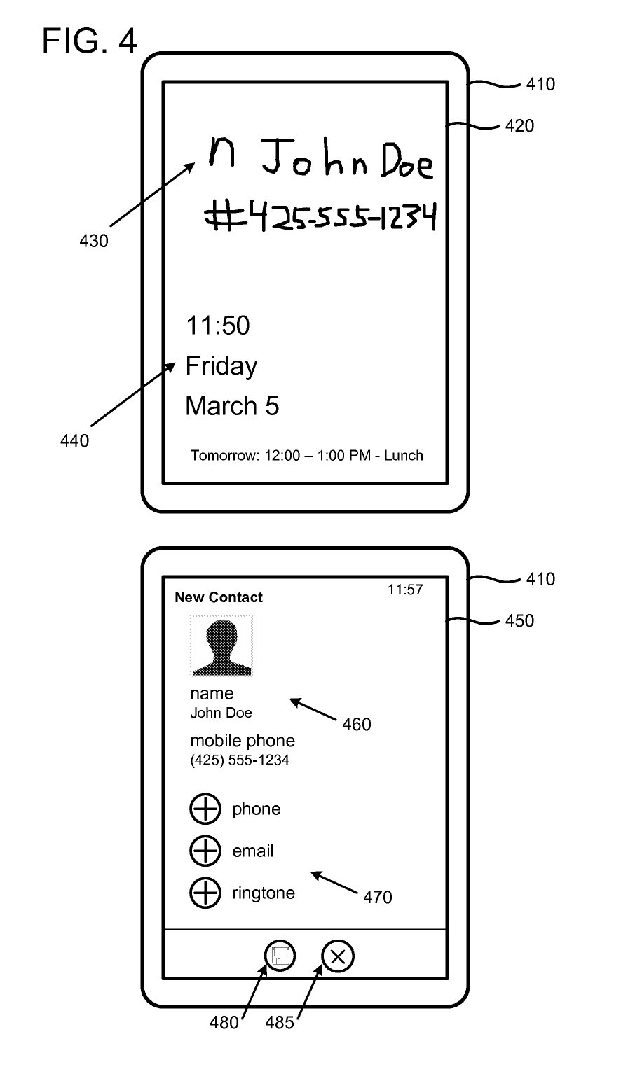

FIG. 4 depicts an example implementation for automatically performing an application-specific action for creating a new contact entry based on global pre-defined symbols entered using digital ink. FIG. 4 depicts a computing device 410 with a display (e.g., a mobile phone, tablet, or another type of computing device). The computing device 410 is capable of receiving digital ink input (e.g., via a digitizer, touchscreen, graphics tablet, etc.).

As depicted in the first example screenshot 420 of the display of the computing device 410, a user has entered digital ink content 430. The digital ink content depicted in the example screenshot 420 is the handwritten digital ink content, “n John Doe” and “#425-555-1234.” The computing device can process the digital ink content (e.g., perform digital ink recognition) to convert the digital ink content to text. Once the digital ink content has been processed, global pre-defined symbols can be recognized. In this example, the letter “n” is a global pre-defined symbol that is associated with an application-specific action for creating a new contact with the name that follows the symbol in the digital ink content. In addition, a second global pre-defined symbol, the pound symbol “#,” is present which indicates a phone number for the new contact.

The example digital ink content 430 can be entered by the user regardless of which application the user is using (e.g., which application is currently being displayed). For example, the digital ink content 430 can be entered when the user is viewing the lock screen or the home screen of the computing device 410 (e.g., as illustrated by the displayed time, date, and calendar item information displayed at 440).

As depicted in the second example screenshot 450 of the display of the computing device 410, a contacts application has been launched as a result of detecting the global pre-defined symbol in the digital ink content 430. As depicted at 460, a new contact has been automatically created for “John Doe” and the contact's phone number “(425) 555-1234” has been automatically entered. The user can perform additional actions for the new contact as depicted at 470, such as enter additional phone numbers, enter an email address, assign a ringtone, etc. Once the user is done, the user can save the contact (e.g., using the save button depicted at 480) or cancel (e.g., using the cancel button depicted at 485).

Using global pre-defined symbols that can be recognized across the computing device (e.g., regardless of which built-in or third-party application the user is using), the user can quickly and efficiently perform actions associated with applications of the computing device. For example, without using global pre-defined symbols, if the user wants to create a new email message to a friend, the user would have to launch the email application, select a user interface element to create a new message, select the recipient field, and select one or more contacts to enter into the recipient field. Using global pre-defined symbols, a user can just enter digital ink content (e.g., “@” contact) and the computing device will automatically launch the email application, lookup the contact, and enter the contact in the recipient field of a new email message.

### Example 8

### Computing Systems

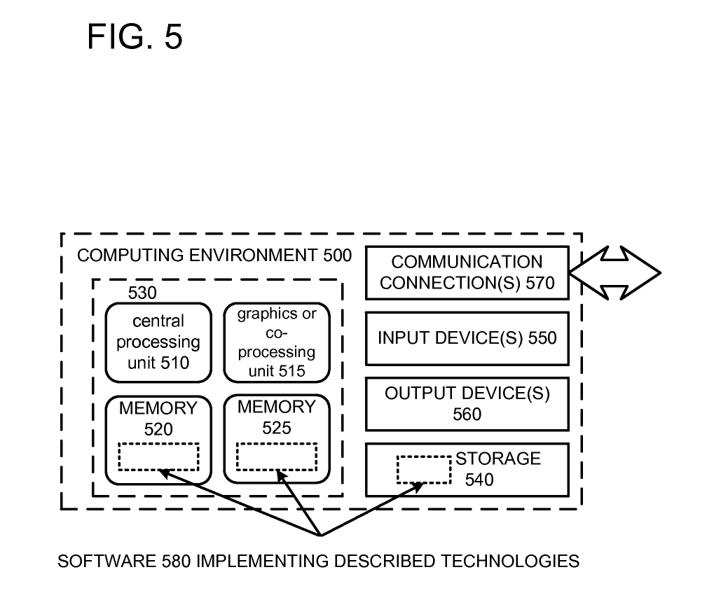

FIG. 5 depicts a generalized example of a suitable computing system 500 in which the described innovations may be implemented. The computing system 500 is not intended to suggest any limitation as to scope of use or functionality, as the innovations may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more innovations described herein.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9

### Mobile Device

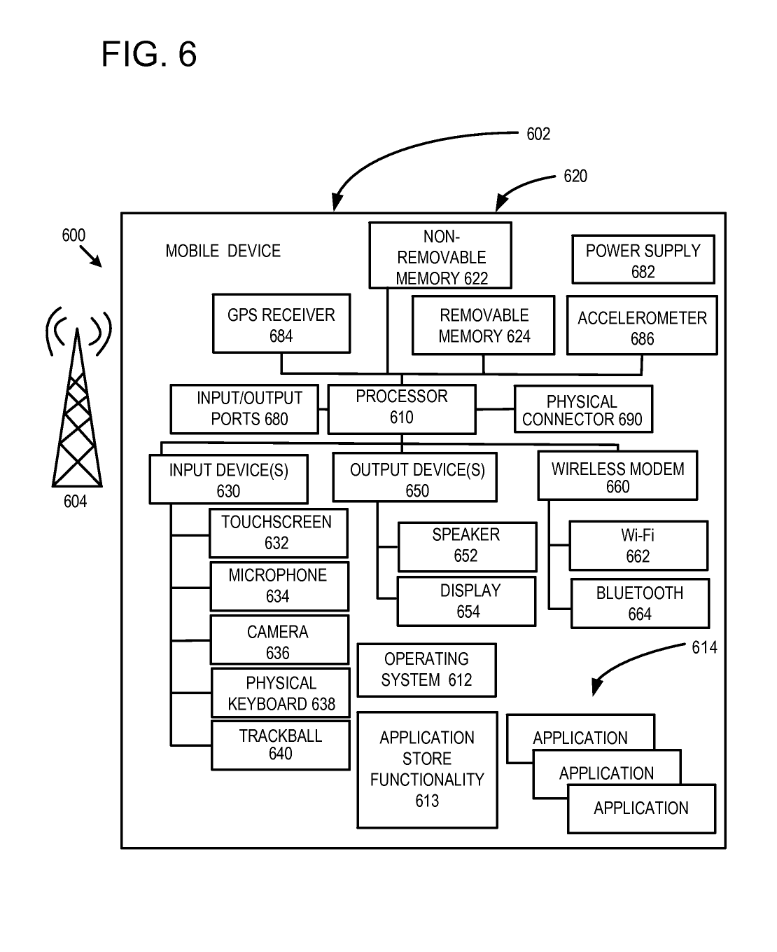

FIG. 6 is a system diagram depicting an exemplary mobile device 600 including a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 604, such as a cellular, satellite, or other network.

The illustrated mobile device 600 can include a controller or processor 610 (e.g., signal processor, microprocessor, ASIC, or other control and processing logic circuitry) for performing such tasks as signal coding, data processing, input/output processing, power control, and/or other functions. An operating system 612 can control the allocation and usage of the components 602 and support for one or more application programs 614. The application programs can include common mobile computing applications (e.g., email applications, calendars, contact managers, web browsers, messaging applications), or any other computing application. Functionality 613 for accessing an application store can also be used for acquiring and updating application programs 614.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touchscreen 632, microphone 634, camera 636, physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touchscreen 632 and display 654 can be combined in a single input/output device.

The input devices 630 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 can comprise speech-recognition software as part of a voice user interface that allows a user to operate the device 600 via voice commands. Further, the device 600 can comprise input devices and software that allows for user interaction via a user's spatial gestures, such as detecting and interpreting gestures to provide input to a gaming application.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be deleted and other components can be added.

### Example 10

### Cloud-Supported Environment

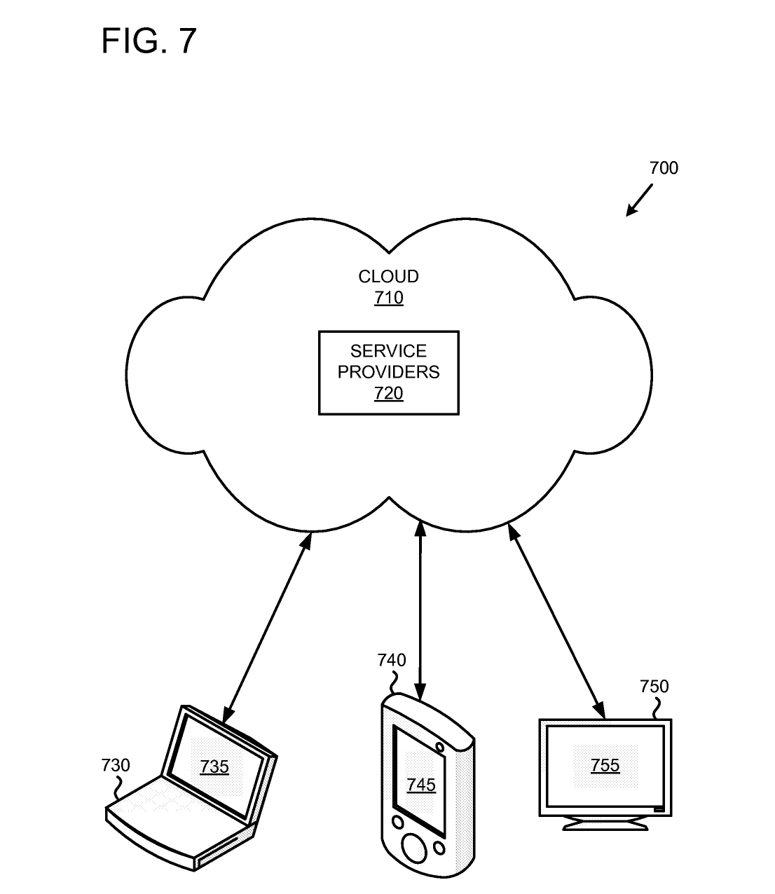

FIG. 7 illustrates a generalized example of a suitable implementation environment 700 in which described embodiments, techniques, and technologies may be implemented. In the example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

### Example 11

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 5, computer-readable storage media include memory 520 and 525, and storage 540. By way of example and with reference to FIG. 6, computer-readable storage media include memory and storage 620, 622, and 624. The term computer-readable storage media does not include communication connections (e.g., 570, 660, 662, and 664) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for automatically performing application-specific actions based on global pre-defined symbols entered using digital ink, the method comprising:
receiving, by the computing device, digital ink content that is input in a digital ink mode;
processing, by the computing device, the received digital ink content;
based on results of the processing, determining, by the computing device, whether the digital ink content comprises a global pre-defined symbol, wherein the global pre-defined symbol is one of a plurality of global pre-defined symbols and associated application-specific actions; and
when the digital ink content comprises the global pre-defined symbol, performing, by the computing device, an application-specific action associated with the global pre-defined symbol.

2. The method of claim 1 wherein processing the received digital ink content comprises performing digital ink recognition.

3. The method of claim 1 wherein the global pre-defined symbol is a globally recognized symbol across built-in and third-party applications of the computing device.

4. The method of claim 1 wherein the global pre-defined symbol is a global system-defined symbol and wherein the application-specific action is a system-defined application-specific action associated with a built-in application.

5. The method of claim 1 wherein the global pre-defined symbol is defined by a user, and wherein the application-specific action is defined by the user.

6. The method of claim 1 wherein the global pre-defined symbol is a first symbol present in the received digital ink content.

7. The method of claim 1 wherein the digital ink content consists of the global pre-defined symbol and additional content, wherein the application-specific action uses the additional content.

8. The method of claim 1 wherein performing the application-specific action associated with the global pre-defined symbol comprises:
launching or switching to an application identified by the application-specific action; and
passing one or more parameters to the application to accomplish the application-specific action.

9. The method of claim 1 wherein the global pre-defined symbol is associated with an application-specific action for sending an email, using a built-in email application, to one or more contacts identified in the digital ink content.

10. A computing device comprising:
a processing unit;
memory; and
an input device supporting digital ink;
the computing device configured to perform operations for automatically performing application-specific actions based on global pre-defined symbols entered using digital ink, the operations comprising:
receiving, via the input device supporting digital ink, digital ink content that is input in a digital ink mode;
processing the received digital ink content;
based on results of the processing, determining whether the digital ink content comprises a global pre-defined symbol, wherein the global pre-defined symbol is one of a plurality of global pre-defined symbols and associated application-specific actions; and
when the digital ink content comprises the global pre-defined symbol, performing an application-specific action associated with the global pre-defined symbol.

11. The computing device of claim 10 wherein processing the received digital ink content comprises performing digital ink recognition.

12. The computing device of claim 10 wherein the global pre-defined symbol is a globally recognized symbol across built-in and third-party applications of the computing device.

13. The computing device of claim 10 wherein the digital ink content consists of the global pre-defined symbol and additional content, wherein the application-specific action uses the additional content.

14. The computing device of claim 10 wherein performing the application-specific action associated with the global pre-defined symbol comprises:
launching or switching to an application identified by the application-specific action; and
passing one or more parameters to the application to accomplish the application-specific action.

15. The computing device of claim 10 wherein the global pre-defined symbol is associated with an application-specific action for sending an email, using a built-in email application, to one or more contacts identified in the digital ink content.

16. The computing device of claim 10 wherein the input device supporting digital ink comprises a digitizer, and wherein the digital ink content is received from a user using a stylus.

17. A computer-readable storage medium storing computer-executable instructions for causing a computing device to perform a method for automatically performing application-specific actions based on global pre-defined symbols entered using digital ink, the method comprising:
receiving digital ink content that is input in a digital ink mode;
processing the received digital ink content, wherein the processing comprises performing digital ink recognition;
based on results of the processing, determining whether the digital ink content comprises a global pre-defined symbol, wherein the global pre-defined symbol is one of a plurality of global pre-defined symbols and associated application-specific actions; and
when the digital ink content comprises the global pre-defined symbol, performing an application-specific action associated with the pre-defined symbol;
wherein the global pre-defined symbol is a globally recognized symbol across built-in and third-party applications of the computing device; and
wherein the global pre-defined symbol is a global system-defined symbol that is associated with an application-specific action for a built-in application.

18. The computer-readable storage medium of claim 17 wherein the digital ink content consists of the global pre-defined symbol and additional content, wherein the application-specific action uses the additional content.

19. The computer-readable storage medium of claim 17 wherein performing the application-specific action associated with the global pre-defined symbol comprises:
launching or switching to the built-in application; and
passing one or more parameters to the built-in application to accomplish the application-specific action, wherein the one or more parameters are obtained from the digital ink content.

20. The computer-readable storage medium of claim 17 wherein the built-in application is an email application, and wherein the global pre-defined symbol is associated with an application-specific action for sending an email to one or more contacts identified in the digital ink content.
